(19) United States
(12) Patent Application Publication
(10) Pub. No.: US 2026/0259611 A1
(43) Pub. Date: Sep. 3, 2026

(54) METHODS AND APPARATUSES FOR HIERARCHICALLY ENCODING SEMANTIC INFORMATION ASSOCIATED WITH A HAPTIC EFFECT

(71) Applicant: InterDigital CE Patent Holdings, SAS, Paris (FR)

(72) Inventors: Gurvan LECUYER, RENNES (FR); Quentin GALVANE, THORIGNE-FOUILLARD (FR); Philippe GUILLOTEL, VERN SUR SEICHE (FR)

(21) Appl. No.: 19/164,124

(22) PCT Filed: Feb. 20, 2024
(86) PCT No.: PCT/EP2024/054271

§ 371 Date: Sep. 10, 2025

(30) Foreign Application Priority Data
Mar. 14, 2023 (EP) 23305342.0
Apr. 6, 2023 (EP) 23305500.3

(51) Int. Cl. G06F 3/01

(52) U.S. Cl. CPC G06F 3/016

(57) ABSTRACT

A method is disclosed. Semantic information associated with at least one haptic effect is first obtained (S700). The semantic based on a multi-layer hierarchical structure of semantic information. The decomposed semantic information is then encoded (S704).

### CROSS REFERENCE TO RELATED APPLICATIONS

This application claims the benefit of European Application No. 23305342.0, filed on Mar. 14, 2023, and of European Application No. 23305500.3, filed on Apr. 6, 2023 which are incorporated herein by reference in their entirety.

### TECHNICAL FIELD

At least one of the present embodiments generally relates to method and apparatus for encoding semantic information associated with a haptic effect. Corresponding rendering method and apparatus are also disclosed.

### BACKGROUND

Fully immersive user experiences are proposed to users through immersive systems based on feedback and interactions. The interaction may use conventional ways of control that fulfill the need of the users. Current visual and auditory feedback provide satisfying levels of realistic immersion. Additional feedback can be provided by haptic effects that allow a human user to perceive a virtual environment with his senses and thus get a better experience of the full immersion with improved realism. However, haptics is still one area of potential progress to improve the overall user experience in an immersive system.

Conventionally, an immersive system may comprise a 3D scene representing a virtual environment with virtual objects localized within the 3D scene. To improve the user interaction with the elements of the virtual environment, haptic feedback may be used through stimulation of haptic actuators. Such interaction is based on the notion of “haptic objects” that correspond to physical phenomena to be transmitted to the user. In the context of an immersive scene, a haptic object allows to provide a haptic effect by defining the stimulation of appropriate haptic actuators to mimic the physical phenomenon on the haptic rendering device. Different types of haptic actuators allow to restitute different types of haptic feedbacks.

An example of a haptic object is an explosion. An explosion can be rendered through vibrations and heat, thus combining different haptic effects on the user to improve the realism. An immersive scene typically comprises multiple haptic objects, for example using a first haptic object related to a global effect and a second haptic object related to a local effect.

The principles described herein apply to any immersive environment using haptics such as augmented reality, virtual reality, mixed reality or haptics-enhanced video (or omnidirectional/360° video) rendering, for example, and more generally apply to any haptics-based user experience. A scene for such examples of immersive environments is thus considered an immersive scene.

Haptics refers to sense of touch and includes two dimensions, tactile and kinesthetic. The first one relates to tactile sensations such as friction, roughness, hardness, temperature and is felt through the mechanoreceptors of the skin (Merkel cell, Ruffini ending, Meissner corpuscle, Pacinian corpuscle). The second one is linked to the sensation of force/torque, position, motion/velocity provided by the muscles, tendons and the mechanoreceptors in the joints. Haptics is also involved in the perception of self-motion since it contributes to the proprioceptive system (i.e. perception of one's own body). Thus, the perception of acceleration, speed or any body model could be assimilated as a haptic effect. The frequency range is about 0-1 KHz depending on the type of modality. Most existing devices able to render haptic signals generate vibrations. Examples of such haptic actuators are linear resonant actuator (LRA), eccentric rotating mass (ERM), and voice-coil linear motor. These actuators may be integrated into haptic rendering devices such as haptic suits but also smartphones or game controllers.

To encode haptic signals, several formats have been defined related to either a high level description using XML-like formats (for example MPEG-V), parametric representation using json-like formats such as Apple Haptic Audio Pattern (AHAP) or Immersion Corporation's HAPT format, or waveform encoding (IEEE 1918.1.1 ongoing standardization for tactile and kinesthetic signals). The HAPT format has been recently included into the MPEG ISOBMFF file format specification (ISO/IEC 14496 part 12). Moreover, GL Transmission Format (glTF™) is a royalty-free specification for the efficient transmission and loading of 3D scenes and models by applications. This format defines an extensible, common publishing format for 3D content tools and services that streamlines authoring workflows and enables interoperable use of content across the industry.

Moreover, a new haptic file format is being defined within the MPEG standardization group and relates to a coded representation for haptics. The encoded haptic description file can be exported either as a JSON interchange format (for example a .gmpg file) that is human readable or as a compressed binary distribution format (for example a .mpg) that is particularly adapted for transmission towards haptic rendering devices.

### SUMMARY

In one embodiment, a method is disclosed for encoding semantic information associated with a haptic effect in a hierarchical manner. Various multi-layer hierarchical structures are defined that are suitable for decomposing semantic information associated with various haptic effects into different levels of semantic information. The decomposed semantic information may be encoded using string of characters. In other examples, the decomposed semantic information may be binary encoded using fix length or variable length encoding. A haptic effect may thus be rendered either from a keyframe or from the decoded semantic information.

### BRIEF DESCRIPTION OF THE DRAWINGS

FIG. 1 illustrates a block diagram of an example of a system in which various aspects and embodiments are implemented.

FIG. 2 illustrates an example of flowchart of a method for encoding an immersive description file;

FIG. 3 illustrates in detail one step of the method for encoding an immersive description file;

FIG. 4 illustrates an example of processes for decoding a distribution stream and rendering an immersive description file;

FIG. 5 illustrates an example of structure for the interchange file format describing an immersive scene;

FIG. 6 illustrates an example of signal coded using two haptic bands;

FIG. 7 depicts a flowchart of an encoding method according to an example;

FIG. 8 depicts a flowchart of a decoding method according to an example; and

FIG. 9 depicts a multi-layer hierarchical structure using four layers for haptic effect semantic representation.

### DETAILED DESCRIPTION

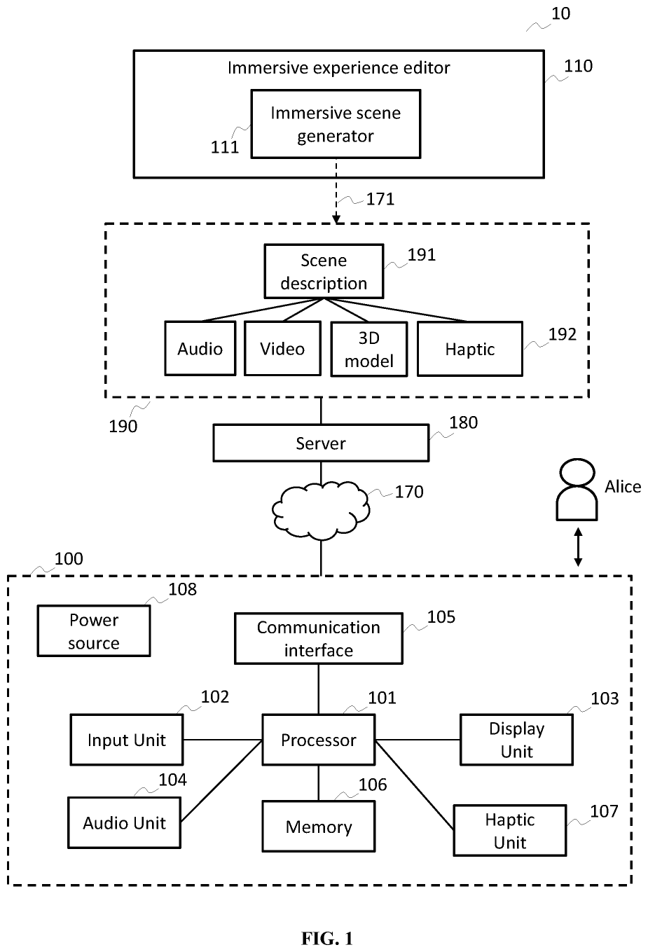

FIG. 1 illustrates a block diagram of an example of an immersive system 10 in which various aspects and embodiments may be implemented. In the immersive system 10, a user Alice uses the haptic rendering device 100 to interact with a server 180 hosting an immersive scene 190 through a communication network 170. This immersive scene 190 may comprise various data and/or files representing different elements (scene description 191, audio data, video data, 3D models, and haptic description file 192) required for its rendering. Although the different elements of the immersive scene 190 are depicted in FIG. 1 as separate elements, the principles described herein apply also in the case where these elements are directly integrated in the scene description and not separate elements. Any mix between two alternatives is also possible, with some of the elements integrated in the scene description and other elements being in separate files. The immersive scene 190 may be generated under control of an immersive experience editor 110 that allows to arrange the different elements together and design an immersive experience. Appropriate description files and various data files representing the immersive experience are generated by an immersive scene generator 111 (a.k.a encoder) and encoded in a format adapted for transmission to haptic rendering devices. The immersive experience editor 110 is typically performed on a computer that will generate immersive scene to be hosted on the server. For the sake of simplicity, the immersive experience editor 110 is illustrated as being directly connected through the dotted line 171 to the immersive scene 190. In practice, the immersive scene 190 is hosted on the server 180 and the computer running the immersive experience editor 110 is connected to the server 180 through the communication network 170.

The haptic rendering device 100 comprises a processor 101. The processor 101 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as haptic signal decoding and rendering, input/output processing, and/or any other functionality that enables the device to operate in an immersive system. The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit 102 may also comprise a digital camera able to capture still pictures or video in two dimensions or a more complex sensor able to determine the depth information in addition to the picture or video and thus able to capture a complete 3D representation. The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example. The processor 101 may be coupled to a communication interface 105 configured to exchange data with external devices. The communication preferably uses a wireless communication standard to provide mobility of the haptic rendering device, such as cellular (e.g. LTE) communications, Wi-Fi communications, and the like. The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In examples, the processor 101 may access information from, and store data in, memory that is not physically located on the haptic rendering device 100, such as memory located on a server, on a home computer, or on another external device.

The processor 101 is coupled to a haptic unit 107 configured to provide haptic feedback to the user, the haptic feedback being described in an haptic description file 192 that is related to the scene description 191 of an immersive scene 190. The haptic description file 192 describes the kind of feedback to be provided according to the syntax described further hereinafter. Such description file is typically conveyed from the server 180 to the haptic rendering device 100. The haptic unit 107 may comprise a single haptic actuator or a plurality of haptic actuators located at a plurality of positions on the haptic rendering device. Different haptic units may have a different number of actuators and/or the actuators may be positioned differently on the haptic rendering device.

The processor 101 may be configured to render a haptic signal. Said otherwise, the processor 101 may be configured to apply a low-level signal to a haptic actuator to render the haptic effect. Such low-level signal may be represented using different forms, for example by metadata or parameters in the description file or by using a digital encoding of a sampled analog signal (e.g. PCM or LPCM).

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While FIG. 1 depicts the processor 101 and the other elements 102 to 108 as separate components, it will be appreciated that these elements may be integrated together in an electronic package or chip. It will be appreciated that the haptic rendering device 100 may include any sub-combination of the elements described herein while remaining consistent with an embodiment. The processor 101 may further be coupled to other peripherals or units not depicted in FIG. 1 which may include one or more software and/or hardware modules that provide additional features, functionality and/or wired or wireless connectivity. For example, the peripherals may include sensors such as a universal serial bus (USB) port, a vibration device, a television transceiver, a hands free headset, a Bluetooth® module, a frequency modulated (FM) radio unit, a digital music player, a media player, a video game player module, an Internet browser, and the like. For example, the processor 101 may be coupled to a localization unit configured to localize the haptic rendering device within its environment. The localization unit may integrate a GPS chipset providing longitude and latitude position regarding the current location of the haptic rendering device but also other motion sensors such as an accelerometer and/or an e-compass that provide localization services. Typical examples of haptic rendering device 100 are haptic suits, smartphones, game controllers, haptic gloves, haptic chairs, haptic props, motion platforms, etc. However, any device or composition of devices that provides similar functionalities can be used as haptic rendering device 100 while still conforming with the present principles.

In an example, the haptic rendering device 100 does not include a display unit 103 but includes a haptic unit. In such embodiment, the device does not render the scene visually but only renders haptic effects. However, the device may prepare data for display so that another device, such as a screen, can perform the display. Example of such devices are haptic suits or motion platforms.

In an example, the haptic rendering device 100 does not include a haptic unit 107 but includes a display unit. In such embodiment, the device does not render the haptic effect but only renders the scene visually. However, the haptic rendering device 100 may prepare data for rendering the haptic effect so that another device, such as a haptic prop, can perform the haptic rendering. Examples of such devices are smartphones, head-mounted displays, or laptops.

In an example, the haptic rendering device 100 neither includes a display unit nor a haptic unit. In such example, the device 100 does not visually render the scene and does not render the haptic effects. However, the device 100 may prepare data for display so that another device, such as a screen, can perform the display and may prepare data for rendering the haptic effect so that another device, such as a haptic prop, can perform the haptic rendering. Examples of such devices are computers, game consoles, optical media players, or set-top boxes.

In an example, the immersive scene 190 and associated elements are directly hosted in memory 106 of the haptic rendering device 100 allowing local rendering and interactions. In a variant, the device 100 also comprises the immersive experience editor 110 allowing a fully standalone operation, for example without needing any communication network 170 and server 180.

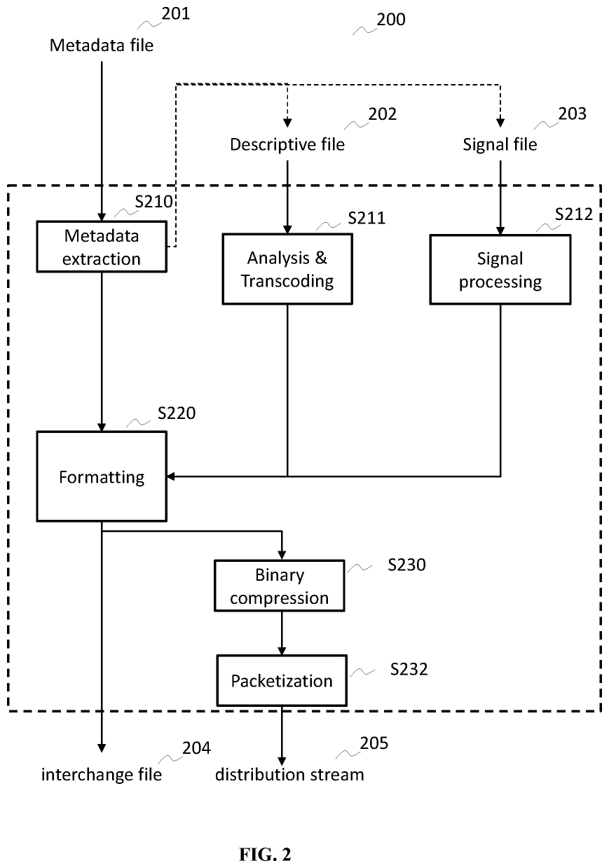

FIG. 2 illustrates an example of flowchart of a method for encoding an immersive description file. This encoding process 200 is for example implemented as a module of the immersive scene generator 111 of an immersive editor 110 and typically performed on a computer generating the files describing the immersive scene. It may also be implemented on a computer or a specific hardware platform dedicated to encoding immersive description files. The inputs of the encoding method are a metadata file 201, at least one descriptive file and/or at least one low-level haptic signal file 203, e.g. in the form of a waveform PCM file. The metadata file 201 is for example based on the ‘OHM’ haptic object file format. The signal file 203 is representing analog signals to be applied to haptic actuators and is conventionally encoded in the form of a waveform PCM file, e.g. in the WAV file format. The descriptive file 202 is for example based on AHAP, IVS, HJIF or HAPT file formats. AHAP is a JSON-like file format that specifies a haptic pattern through key-value pairs, analogous to a dictionary literal, except in a text file.

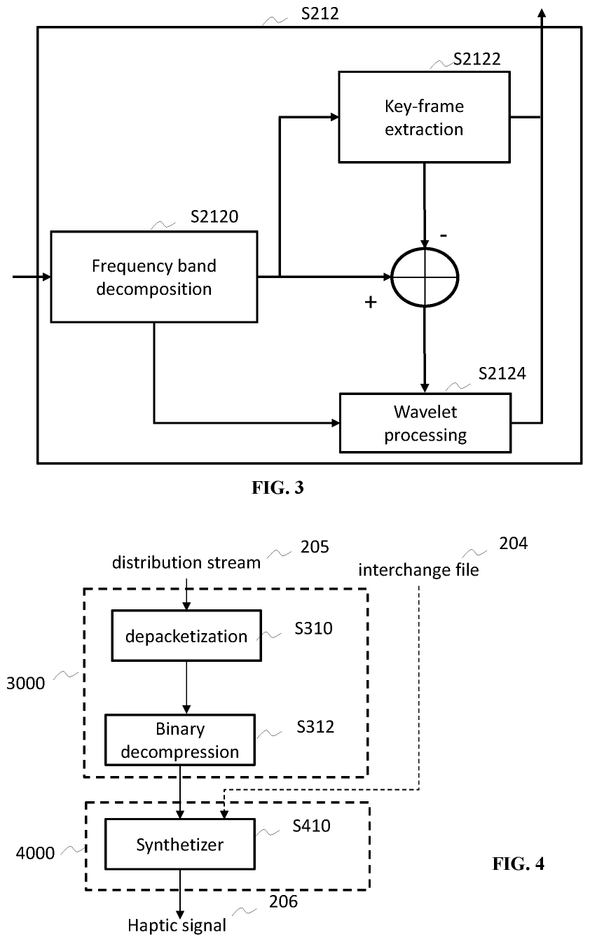

Metadata are extracted S210 from the metadata file 201, allowing to identify the descriptive files and/or signal files. Descriptive files are analyzed and transcoded in step S211. In step a S212, signal files 203 are processed using common signal analysis methods to generate keyframes and either interpole between keyframes or use wavelet coding (based on SPIHT, English acronym of “Set Partitioning In Hierarchical Trees”) to generate a binary encoded stream. The step S212 is further detailed on FIG. 3. It comprises decomposing the signal in frequency bands at a step S2120 and extracting keyframes (step S2122) or wavelet coefficients (S2124).

Back to FIG. 2, the interchange file 204 is then generated in step S220, in compliance with the data format according to one of the embodiments described herein. The interchange file 204 may be compressed (more precisely binary encoded) in step S230 and further packetized in step S232 to be distributed in a transmission-friendly form such as the distribution stream 205, more compact than the interchange file 204.

The interchange file 204 is a human readable file for example based on glTF, XML or JSON formats. The distribution stream 205 is a binary encoded stream possibly packetized for example based on MPEG file formats adapted for streaming or broadcasting to a decoder. In an example, the distribution stream 205 is an MIHS stream (English acronym of. MPEG-I Haptic Stream).

FIG. 4 illustrates an example of processes for decoding 3000 the distribution stream 205 and rendering 4000 an immersive description file. The streamed or broadcasted distribution stream 205 may first be depacketized in a step S310. This step is the inverse of the packetization step S232 on the encoder side. The obtained data are further decoded in a step S312. The output of the step S312 is an interchange file 204. This step is the inverse of the compression step S230 on the encoder side.

In the rendering process 4000, the interchange file 204 output by the step S312 may be analyzed in a synthetizing step S410 to generate an appropriate haptic signal 206. In a variant, represented by a dotted line, the haptic signal 206 may be directly synthetized from the interchange file 204 generated by the encoding process 200. The decoding process 3000 and the rendering process 4000 are for example both implemented by the haptic rendering device 100 of FIG. 1. The decoding process 3000 and the rendering process 4000 may also be performed by a device separate from—but communicating with—the haptic rendering device, for example by a computer, a set top box, a smartphone, a computing instance in the cloud.

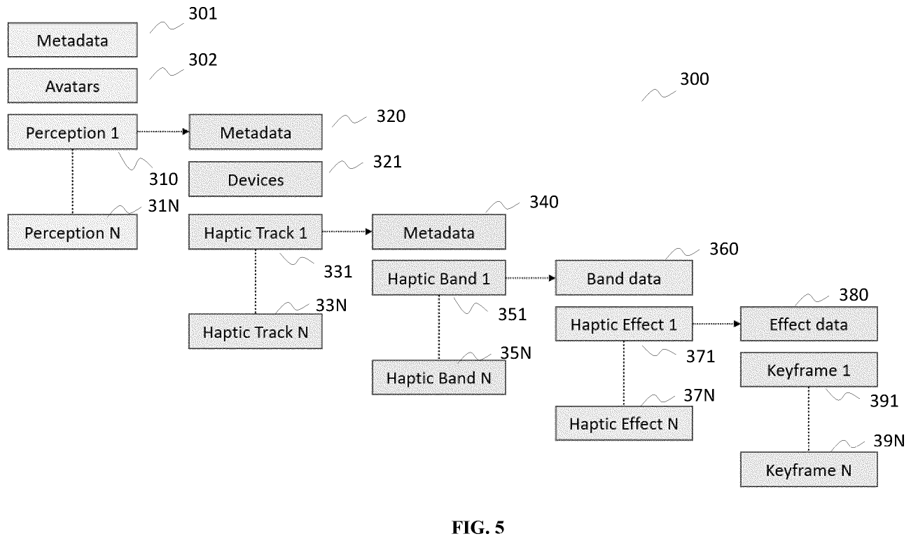

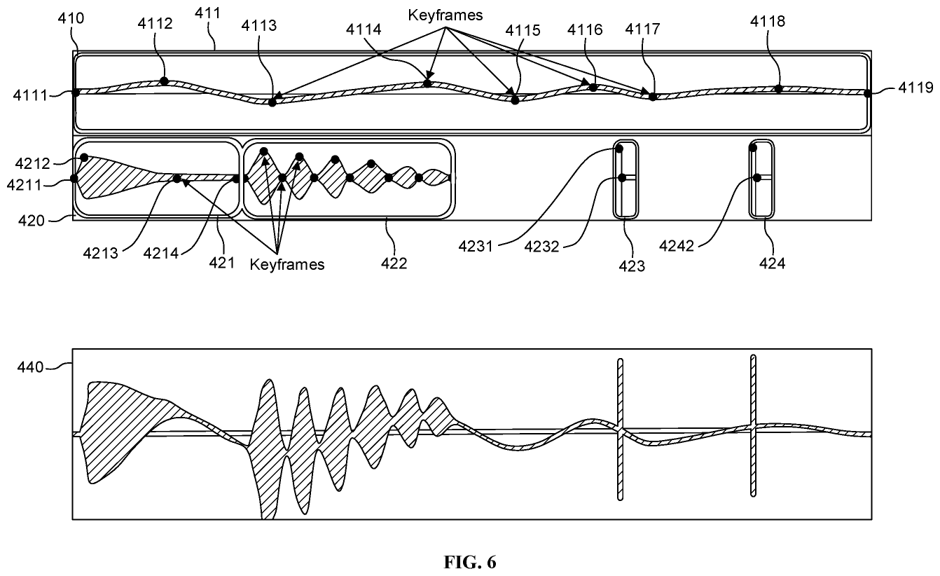

FIG. 5 illustrates an example of structure for the interchange file format describing an immersive scene. The data structure 300 represents the immersive scene 190. It can be decomposed in a set of layers. At an upper layer, metadata 301 describe some high-level metadata information regarding the overall haptic experience defined in the data structure 300 and a list of avatars (i.e., body representation) later referenced in the file. These avatars allow to specify a target location of haptic stimuli on the body. The haptic effects are described through a list of perceptions 310 to 31N. These perceptions correspond to haptic signals associated with specific perception modalities such as vibration, force, position, velocity, temperature, etc. A perception comprises metadata 320 to describe the haptic content of the signal, devices 321 to describe specifications of the haptic devices for which the signal was designed and a list of haptic tracks 331 to 33N. A haptic track comprises metadata 340 to describe the content of the track, the associated gain value, a mixing weight, body localization information and a reference to haptic device specification (defined at the perception level). The track finally contains a list of haptic bands 351 to 35N, each band defining a subset of the signal within a given frequency range. For example, the haptic band 351 may correspond to the range of frequencies from 0 to 50 Hz while the haptic band 35N may correspond to the range of frequencies over 2 kHz. A haptic band comprises some band data 360 to describe the frequency range of the band, the type of encoding modality (Vectorial or Wavelet), the type of band (Transient, Curve and Wave) and optionally the type of curve (Cubic, Linear or unknown) or the window length. A haptic band is defined by a list of haptic effects 371 to 37N. Finally, a haptic effect comprises effect data 380 and a list of keyframes 391 to 39N, a keyframe being defined by a position (i.e. a temporal reference), a frequency and an amplitude. The effect data describes the type of base signal selected amongst Sine, Square, Triangle, SawToothUp, and SawToothDown as well as provide temporal references such as timestamps. The low-level haptic signal can then be reconstructed by combining the keyframes of the haptic effects in the different bands, as illustrated in the example of FIG. 6.

FIG. 6 illustrates an example of signal coded using two haptic bands. With this technique, a low-level haptic signal is encoded using two frequency bands, namely a low frequency band 410 and a high frequency band 420, each of them defining a part of the signal in a given frequency range. In this example, the low frequency band corresponds to frequencies below 72.5 Hz Hz while the high frequency band corresponds to frequencies equal to or higher than 72.5 Hz. On the rendering side, the device combines the two parts together (i.e. adding them together) to generate the final haptic signal 440.

The data for a frequency band may be reconstructed based on keyframes and according to a type of haptic band selected amongst Transient, Curve and Wave bands. Additionally, for Wave bands, two types of encoding modalities can be used: Vectorial or Wavelet. Each band is composed of a series of Effects and each Effect is defined by a list of Keyframes that are represented as dots in the figure. The data contained in the effects and keyframes is interpreted differently for different types of haptic bands and encoding modalities. For a Transient band, each effect stores a set of keyframes defining a position, an amplitude, and a frequency. A keyframe represents a transient event. The signal may be reconstructed using the type of periodic base signal specified in the effect metadata with the amplitude specified in the keyframe and the period given by the frequency of the keyframe. A transient event is a very short signal generated only for a few periods. The number of generated periods is determined by the decoder.

For a Curve band, each effect stores a set of keyframes defining a position (i.e. a temporal reference) and an amplitude. The keyframes represent control points of a curve and an interpolation is performed to generate the curve from the control points. The type of interpolation function is either cubic or linear and is specified in the metadata of the band (380 in FIG. 5). The signal may be reconstructed by performing an interpolation between the amplitudes of keyframes according to their temporal references.

For Vectorial Wave bands, the effect stores a set of keyframes defining a position (i.e. a temporal reference), an amplitude and a frequency. In this case, the signal is generated using the type of periodic base signal specified in the effect metadata with the amplitude specified in the keyframe and the period given by the frequency of the keyframe.

For Wavelet band, SPIHT wavelet encoding scheme may be used. For example, for the Wavelet band, the effect may store the contents of one wavelet block. It contains a keyframe for every coefficient of the wavelet transformed and quantized signal, indicating the amplitude value of the wavelet. The coefficients are scaled to a range of [−1,1]. Additionally, the original maximum amplitude is stored in a keyframe, as well as the maximum number of used bits. In this case, the signal may be reconstructed using the coefficients to perform an inverse wavelet transform.

The frequency band decomposition may use a Low Pass Filter and a High pass filter to split the signal into a low frequency band and a high frequency band. The two bands are then processed differently. Various methods can be used for the encoding of the high frequency part. A first solution is to split the high frequency signal into smaller fixed length windows and use Short-time Fourier Transform (STFT) to decompose the signal in the frequency spectrum. Another solution is to use wavelet transforms to encode the high frequencies. The data structure illustrated in FIG. 5 allows to define multiple bands with different frequency ranges. These bands are used to store the coefficients of the Fourier or Wavelet Transforms. For the low frequency part of the signal, the data of this frequency band is stored through a list of keyframe points defined by a timestamp and an amplitude. The data also contains information relative to the type of interpolation used to reproduce the signal of this band. The keyframes (i.e., control points) defining the low frequency band are obtained by simply extracting the local extrema of the low frequency signal.

In the example of FIG. 6, the low frequency band 410 is defined as a Curve band using a single effect 411. Such representation is particularly adapted to the low frequency part of the signal. The effect 411 is defined by the keyframes 4111, 4112, 4113, 4114, 4115, 4116, 4117, 4118, 4119. The signal for the low frequency band is generated by a cubic interpolation between these keyframes. The high frequency band 420 is defined by 4 effects 421, 422, 423, 424. The effect 421 is defined as a Vectorial band defined by 4 keyframes 4211, 4212, 4213, 4214.

While FIG. 6 depicts an example with a set of two bands defining a range for low frequencies and a range for high frequencies, the present principles also apply in the case where more than two ranges of frequencies are used. In this latter case, the low frequency band becomes the lowest frequency band and the high frequency band becomes the highest frequency band. The lowest frequency band may for example be encoded using a curve band using a single effect, as represented by the low frequency band 410 of FIG. 6. Other frequency bands may be encoded with any of the other type of encoding, for example using a vectorial wave band based on wavelets, as represented by the high frequency band 420 of FIG. 6 but using multiple instances of encoding, one for each band of frequencies.

One advantage of this solution with regards to the structure is that the signal data is easy to package and particularly convenient for streaming purposes Indeed, with such linear structure, the data can be easily broken down to small consecutive packages and does not require complicated data-pre-fetching operations. The signal is easily reconstructed by patching the packages back together to ensure a smooth playback of the signal. It may also be reconstructed by only taking the low frequency part and reconstruct a lower quality (but potentially sufficient) signal without taking into account the high frequency band.

Haptic effect can be further described using semantic information to identify a type of the effect. This semantic information may come in addition to the keyframes and/or wavelet coefficients. This semantic information can be useful to sort haptic effects and build library of haptic effects following specific rules. For creators, the use of semantic information to describe an haptic effect ease the design of haptic experience. In the industry, haptic editor software already implements such libraries of haptic effects with semantic information to sort haptic effects. This type of semantic information is however not represented in the current version of the formats, i.e. interchange file format and distribution stream format. The current version of the format (and the codec) encodes an effect using keyframes or wavelet coefficients and different information such as the frequency or the amplitude of the signal for each keyframes.

A first limitation of the current codec is that it forces artists to create haptic effects using ad hoc haptic editor software that allow to manipulate signal. Such tools require specific knowledge about both the haptic editor software and the human mechanoreceptor for which the haptic effect is designed. While designing haptic effect usually requires the use of such software, user-friendly tool could help adoption and design of haptic for broader applications. A second limitation of the current codec concerns the device adaptation issue. The current format allows to embed metadata for the device targeted by the haptic experience providing minimum requirement to perform device adaptation. Adapting haptic experience designed for one device to another device is not trivial.

A third limitation of the codec lies in the design of device specific effect such as washout effects. Some devices require specific effects to be performed along the haptic experience to respect the device specification. For example, kinesthetic devices have position limitations that can prevent a haptic effect to be played when the position of the actuator reaches the bounds of the device. Special effect can be played to alter the rendering of the effect to emulate the haptic experience while forcing the position of the actuator to reset. The current format does not make it possible to easily design device specific effects.

Adding semantic information to haptic effect may help improving the user experience.

As an example, semantic information may be stored for an haptic effect using a string (a.k.a string of characters), i.e. a series of characters.

Using such a string may render difficult the storage or transmission of semantic information in the binary format, e.g. in a binary distribution stream 205. There are two ways to store string in binary format. In a first way, the number of characters is fixed which causes issue if too few characters are allowed. On the other hand, if too many characters are allowed the bitrate of the haptic experience is impacted. The second way comprises adding a first field storing the number of characters followed by a list of characters. This causes a varying size of the binary format and does not prevent the use of too many characters.

A further limitation caused by using a string of characters to describe the semantic information of an haptic effect concerns the interpretation of the stored value. While strings enable human readable information, it is more difficult for a computer to interpret it and thus requires extra effort for software development.

To overcome these drawbacks, a tag may be used with a predefined enumeration of common haptic effects. For the binary format, a number of bits may be allocated to this enumeration and a list of haptic effect may be provided. An example of such a list is given below.

//weapons&combat
Bullet
Explosion
Shotgun
Pistol
Rifle
Punch
Kick
Engine
Reload.
. . .

### //Music

Snare
Bass drum
Tom
Stand Tom
hi-Hat
Crash Cymbal
Ride Cymbal
. . .

### //UX

Click
Double Click
Confirmation
Wrong
Ring
Message
. . .

### //Car

Engine
Crash
Gear
. . .

### //Character Movements

Footstep
. . .

### //Ambient

water drop
rain
. . .

This solution is however not optimal, especially for the binary format as it forces to use a fixed number of bits no matter the type of haptic effect.

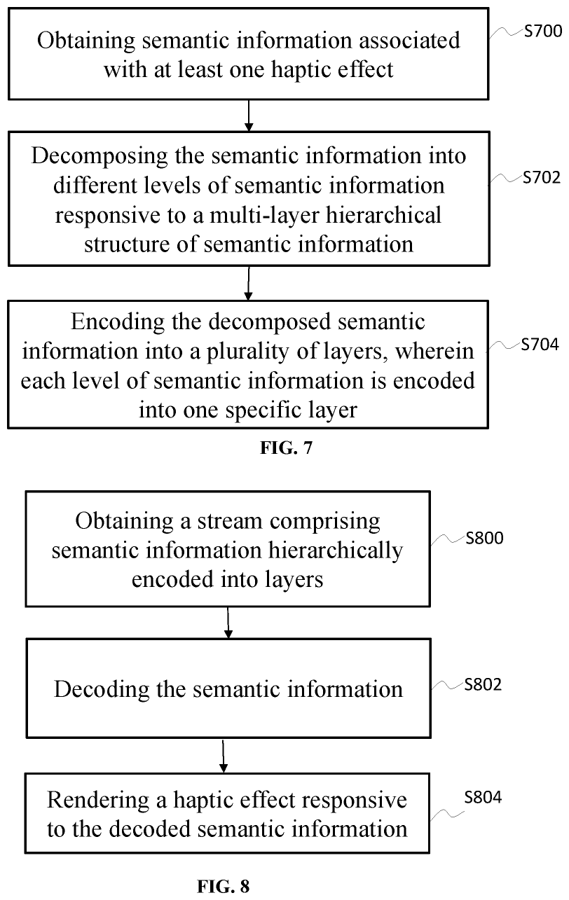

In contrast, a method for encoding semantic information associated with a haptic effect is disclosed below with reference to FIG. 7 that makes it possible to embed semantic information for haptic effect compatible with the need of the current encoding scheme. More precisely, the method provides scalability with a multi-layer hierarchical structure that can be adapted to different use cases. In addition, in some examples, the impact on the bitrate of the binary format may be limited by using a flexible approach that can be adapted to different use cases. In an example, streaming bitrate is optimized using the proposed multi-layer semantic information encoding. Advantageously, the method enables data reduction and optimization based on semantic information.

Besides, the encoding of such semantic information eases the creation process of haptic content by providing a semantic annotation of the effect which could be used instead of the keyframe representation. It further eases the device adaptation process by making it possible for each haptic device to use its own haptic effect library, all effect libraries across devices sharing the same semantics. In an example, the haptic device may generate its own effect from its library knowing the semantic information instead of using the haptic effect described in the interchange file 204 thus ensuring that the effect is well adapted to it.

The method provides a generic approach that could be used with any hierarchical semantic structure.

FIG. 7 depicts a flowchart of an encoding method according to an example. The method makes it possible to encode an haptic effect semantic using a multi-layer hierarchical structure. The hierarchical structure allows to cluster haptic effects regarding their type, domain of application, or any other relevant rules to organize the haptic effects in groups.

In a step S700, semantic information associated with at least one haptic effect is obtained. For example, the semantic information is obtained from the extracted metadata.

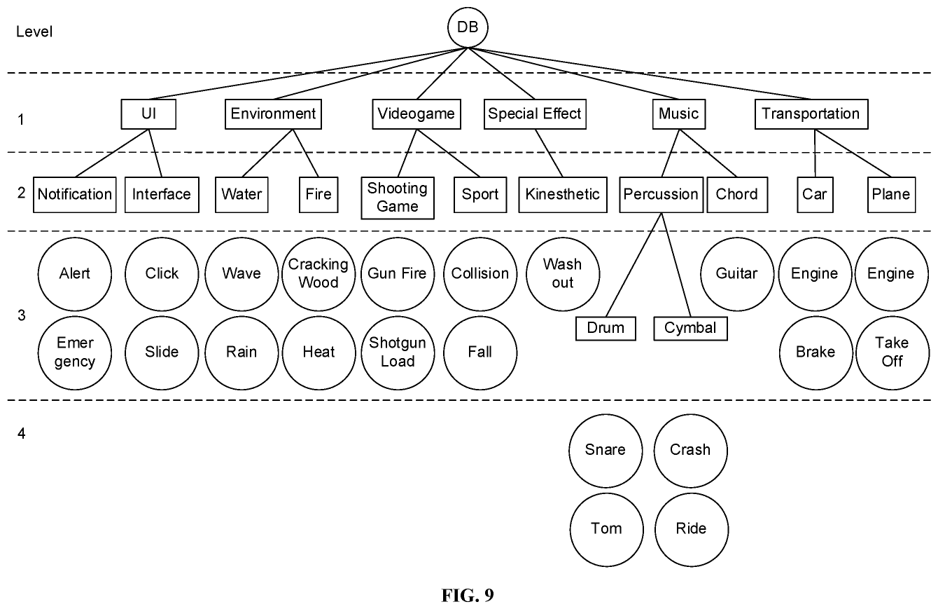

In a step S702, said semantic information is decomposed into different levels (a.k.a layers) of semantic information organized in a hierarchical manner from a high level semantic information to a low level semantic information. The terms “level” and “layer” may be used interchangeably. This decomposition is made according to a multi-layer hierarchical structure. The lower the level, more precise the semantic information. An example of such decomposition is illustrated by FIG. 9 which depicts a multi-layer hierarchical structure using 4 layers for haptic effect semantic representation. Each element in the structure (a.k.a semantic tag) represents either a concept that can be split in different concepts in a lower level or in different haptic effects. Furthermore, this representation is scalable. The first layer contains 6 elements which define concepts since each of them have at least one child. As an example, the semantic information “heat” is decomposed into 3 levels of semantic information “environment” for first level, “fire” for second level and “heat” for third level. In another example, the semantic information “snare” is decomposed into 4 levels of semantic information “music” for first level, “percussion” for second level, “drum” for the third level and “snare” for fourth level. The semantic information is thus represented in a hierarchical manner providing more precise information from layer to layer. The multi-layer hierarchical structure depicted on FIG. 9 is an example. Different data-structures may be used to represent the semantic information in a hierarchical manner. Each layer consists in a list of elements. If an element has one or more children, it is a concept, otherwise it represents a haptic effect. A concept can also be represented by a generic haptic effect. It can be useful in case of vertical pruning (i.e. the pruning of layers). The hierarchical structure allows for pruning mechanism, either limiting the structure depth (vertical pruning) or the number of branches used (horizontal pruning). It gives more flexibility than a representation based on an enumeration which requires the use of a fixed number of bits.

The following Table 1 gather what could be considered as a deep structure with 4 layers of semantic spread over 8 initial concepts (UX, Character Movements, Specific effect, weapons and combat, ambient, texture, music and vehicles) in the first layer.

TABLE 1

| Layer 1 | Layer 2 | layer3 | Layer 4 | | | | | | |
|---|---|---|---|---|---|---|---|---|---|
| UX | Button | click | simple | double | | | | | |
| | Notification | Confirmation | Wrong | ring | message | . . . | | | |
| Character | Humanoid | displacement | footstep | jumping | falling | crawling | swimming | . . . | |
| Movements | | interaction | collision | grabbing | touching | swiping | . . . | | |
| | Robotic | displacement | footstep | jumping | falling | crawling | . . . | | |
| | | interaction | collision | grabbing | touching | swiping | . . . | | |
| | Slimy | displacement | falling | crawling | swimming | | | . . . | |
| | | interaction | collision | grabbing | touching | swiping | . . . | | |
| | . . . | | | | | | | | |
| Specific | Kinesthetic | washout | | | | | | | |
| effect | . . . | | | | | | | | |
| weapons & | cold weapon | melee | blade | fist | | | | | |
| combat | | weapons | | | | | | | |
| | | ranged | hand-thrown | elastic | pneumatic | | | | |
| | | weapons | | propulsion | | | | | |
| | firearm | handguns | semi-automatic | silent | revolver | | | | |
| | | Rifles & | sniper rifle | automatic | assault rifles | shotgun | | | |
| | | shotguns | | rifles | | | | | |
| | | machine guns | submachine guns | machine | | | | | |
| | | | | guns | | | | | |
| | electroshock | taser | | | | | | | |
| | weapon | electric shock | | | | | | | |
| | | prods | | | | | | | |
| | explosion | Mines | | | | | | | |
| | | missile | | | | | | | |
| | | grenade | | | | | | | |
| Ambient | Air | wind blow | temperature | . . . | | | | | |
| | Water | rain | water fall | water drop | . . . | | | | |
| | Fire | heat | . . . | | | | | | |
| | Earth | earthquake | . . . | | | | | | |
| Texture | Rough | rock | gravel | . . . | | | | | |
| | Smooth | Wood | Hard wood | Soft wood | . . . | | | | |
| | | metal | Copper | Zinc | Nickel | Tin | Lead | . . . | |
| | bumpy | gravel | . . . | | | | | | |
| | . . . | | | | | | | | |
| Music | Percussion | pitched | glockenspiel | crotales | cowbell | . . . | | | |
| | | percussion | | | | | | | |
| | | unpitched | snare drums | tom | kick drum | cymbal | . . . | | |
| | | percussion | | | | | | | |
| | string | plucking | guitar | bass | . . . | | | | |
| | instrument | bowing | cello | violin | . . . | | | | |
| | | striking | piano | . . . | | | | | |
| | | other | . . . | | | | | | |
| | Wind | brass | horns | trumpet | trombones | . . . | | | |
| | instrument | instruments | | | | | | | |
| | | woodwind | flutes | oboes | clarinets | saxophones | . . . | | |
| | | instruments | | | | | | | |
| Vehicles | Motorized | Cars | Engine | Doors | brake | sport | drift | tires | . . . |
| | | | | | | engine | | gripping | |
| | | plane | engine | landing | take off | flaps moving | landing | air | |
| | | | | | | | gear in/out | friction | |
| | | train | engine | pantograph | air friction | brakes | wheel friction | | |
| | | | | moving | | | | | |
| | | boat | water resistance | engine | . . . | | | | |
| | unmotorized | bike | road friction | bump | brake | . . . | | | |
| | | roller | road friction | . . . | | | | | |
| | | scooter | road friction | brake | | | | | |
| | | skateboard | road friction | . . . | | | | | |

A second representation using 3 layers is proposed in Table 2 below. This second representation contains less level of abstraction but still covers most of the possibilities while limiting the level of details. For example, for the concept “Music”, the “percussion” concept in the third layer is split into two haptic effects, namely hard material and bouncy material while in Table 2, 7 haptic effects are associated with “percussion”, namely glockenspiel, crotale, cowbell, snare drums, tom, kick drum and cymbal.

TABLE 2

| Layer 1 | Layer 2 | Layer 3 | | | | | | | |
|---|---|---|---|---|---|---|---|---|---|
| UX | Button | click | double click | | | | | | |
| | Notification | Confirmation | Wrong | ring | message | . . . | | | |
| Character | displacement | footstep | jumping | falling | crawling | swimming | . . . | | |
| Movements | interaction | collision | grabbing | touching | swiping | . . . | | | |
| | . . . | | | | | | | | |
| Specific | Kinesthetic | washout | | | | | | | |
| effect | . . . | | | | | | | | |
| weapons & | cold weapon | blade | hit | hand- | elastic | pneumatic | | | |
| combat | | | | thrown | propulsion | | | | |
| | firearm | handguns | Rifles | Shotgun | | | | | |
| | electroshock | taser | electric shock | stun shields | | | | | |
| | weapon | | prods | | | | | | |
| | explosion | Mines | missile | grenade | | | | | |
| Ambient | Air | wind blow | Heat | Cold | | | | | |
| | Water | rain | waterfall | water drop | . . . | | | | |
| | Fire | heat | . . . | | | | | | |
| | Earth | earthquake | . . . | | | | | | |
| Texture | Rough | rock | Gravel1 | . . . | | | | | |
| | Smooth | Wood | metal | . . . | . . . | | | | |
| | bumpy | Gravel2 | . . . | | | | | | |
| | . . . | | | | | | | | |
| Vehicles | Motorized | Engine | Doors | brake | mechanical | drift | tires gripping | air friction | vehicle bump |
| | | | | | part moving | | | | |
| | Unmotorized | road friction | brake | bump | | | | | |
| Music | Percussion | hard material | bouncy | | | | | | |
| | | (cymbals) | material | | | | | | |
| | | | (drum) | | | | | | |
| | string instrument | plucking | bowing | striking | other | | | | |
| | | (guitar) | (violin) | (piano) | | | | | |
| | Wind instrument | brass | woodwind | | | | | | |
| | | instruments | instruments | | | | | | |

A third representation using 2 layers is given Table 3 below. This 2-layer representation contains no level of abstraction and maximizes the number of effects stored in the structure.

TABLE 3

| Layer 1 | Layer 2 |
|---|---|
| UX | Click |
| | Double click |
| | Success |
| | Error |
| | Alarm |
| | Confirmation |
| | Wrong |
| | Ring |
| | Message |
| Avatar | Footstep |
| | Jumping |
| | Fall |
| | Crawl |
| | Swim |
| | Collision |
| | Grab |
| | Touch |
| | Swip |
| Specific effect | Washout |
| | Noise |
| weapons & | Blade |
| combat | Hit |
| | hand-thrown |
| | elastic propulsion |
| | pneumatic |
| | handguns |
| | Rifles |
| | Shotgun |
| | Gun |
| | Machinegun |
| | Taser |
| | Electric shock |
| | Mines |
| | missile |
| | grenade |
| | Blast |
| Ambient | wind blow |
| | Heat |
| | Cold |
| | rain |
| | waterfall |
| | water drop |
| | Electric buzz |
| | Ignition |
| | Cracks |
| | earthquake |
| | Sparks |
| | Thunderbolt |
| Texture | Rock |
| | Gravel |
| | Sand |
| | Wood |
| | Metal |
| | Plastic |
| Vehicles | Engine |
| | Doors |
| | Brake |
| | Mechanical Contraption |
| | Drift |
| | Road friction |
| | brake |
| | Road bump |
| | Tires |
| | air friction |
| Music | hard material (cymbals) |
| | bouncy material (drum) |
| | plucking (guitar) |
| | bowing (violin) |
| | striking (piano) |
| | brass instruments |
| | woodwind instruments |

Tables 1, 2 and 3 thus detail all the haptic effects that can be represented using semantic information decomposed into a plurality of layers.

In an example, the multi-layer hierarchical structure may be adapted to the profile and profile level of the codec. Indeed, two profiles: a main profile, and a simple parametric profile are currently defined within MPEG standardization group for the current version of the codec designed to encode haptic signals. The Simple Parametric Profile is developed to facilitate the adoption of the MPEG format for the existing set of haptics interface and peripheral existing on the market. It targets simple devices such as mobile phones or game controllers. The Main profile targets advanced platforms such as simulators or motion platforms. It allows scalable applications and very high fidelity encoding.

For both profiles, two profile levels are defined limiting the number of channels, bands perception modalities and fixing the timescale. Table 4 provides a comparison between the two profiles for the two profile levels.

TABLE 4

| | | | | | Curve | Effects | |
|---|---|---|---|---|---|---|---|
| Profile | #Level | #channels | #bands | Perceptions | types | types | Timescale |
| Simple | 1 | 0-127 | 0-7 | Force | Transient | no | 1000 |
| Parametric | | | | Vibration | Curve | composite | |
| | | | | Stiffness | Vectorial | | |
| | | | | Vibrotactile | | | |
| | | | | Texture | | | |
| | 2 | 0-65535 | 0-63 | All | | | |
| Main | 1 | 0-127 | 0-7 | All | All | All | No |
| | | | | | | | additional |
| | | | | | | | constraint |
| | 2 | 0-65535 | 0-255 | | | | |

Considering that Table 2 represents the hierarchical structure for the main profile level 2. The representation store 63 final effects spread over 8 initial concepts and 21 intermediate concepts.

This representation could be reduced using horizontal pruning (i.e. the pruning of concepts) for the simple parametric profile level 2 with the 4 first initial concepts as illustrated by Table 5. This pruned representation contains 4 initial concepts with 9 intermediates concepts and 31 effects stored. The 4 initial concepts from Table 2 that are kept in Table 5 are identified to be the concepts most relevant for the device aimed by the simple parametric profile.

TABLE 5

| Layer 1 | Layer 2 | Layer 3 | | | | | |
|---|---|---|---|---|---|---|---|
| UX | Button | click | double click | | | | |
| | Notification | Confirmation | Wrong | ring | message | . . . | |
| Character | displacement | footstep | jumping | falling | crawling | swimming | . |
| Movements | | | | | | | . |
| | | | | | | | . |
| | interaction | collision | grabbing | touching | swiping | . . . | |
| | . . . | | | | | | |
| Specific | Kinesthetic | washout | | | | | |
| effect | . . . | | | | | | |
| weapons & | cold weapon | blade | hit | hand-thrown | elastic | pneumatic | |
| combat | | | | | propulsion | | |
| | firearm | handguns | long gun | rifles & | machine guns | | |
| | | | | shotgun | | | |
| | electroshock | taser | electric shock | stun shields | | | |
| | weapon | | prods | | | | |
| | explosion | Mines | missile | grenade | | | |

In the same way, the hierarchical structure could be further pruned vertically to keep the higher-layer concepts, e.g. to be used in the case of main profile level 1. Table 6 thus shows an example of a hierarchical structure for the main profile level 1.

TABLE 6

| Layer 1 | Layer 2 | layer3 |
|---|---|---|
| UX | Button | click |
| | Notification | Confirmation |
| Character | Humanoid | displacement |
| Movements | | interaction |
| | Robotic | displacement |
| | | interaction |
| | Slimy | displacement |
| | | interaction |
| | . . . | |
| Specific | Kinesthetic | washout |
| effect | . . . | |
| weapons & | cold | melee weapons |
| combat | weapon | ranged weapons |
| | firearm | handguns |
| | | long gun |
| | | rifles & shotgun |
| | | machine guns |
| | electroshock | taser |
| | weapon | electric shock prods |
| | explosion | Mines |
| Ambient | Air | wind blow |
| | Water | rain |
| | Fire | heat |
| | Earth | earthquake |
| Texture | Rough | roc |
| | Smooth | Wood |
| | bumpy | gravel |
| | . . . | |
| Music | Percussion | pitched percussion |
| | | unpitched percussion |
| | string | plucking |
| | instrument | bowing |
| | | striking |
| | | other |
| | Wind | brass instruments |
| | instrument | woodwind instruments |
| Vehicles | Motorized | Cars |
| | | plane |
| | | train |
| | | boat |
| | unmotorized | bike |
| | | roller |
| | | scooter |
| | | skateboard |

In the same way, the hierarchical structure could be further pruned vertically and horizontally, e.g. to be used in the case of simple parametric profile level 1. Table 7 thus shows an example of a hierarchical structure for the simple parametric profile level 1. Only 18 haptic effects are represented spread over 4 initial concepts.

TABLE 7

| Layer 1 | Layer 2 | layer3 |
|---|---|---|
| UX | Button | click |
| | Notification | Confirmation |
| Character | Humanoid | displacement |
| Movements | | interaction |
| | Robotic | displacement |
| | | interaction |
| | Slimy | displacement |
| | | interaction |
| | . . . | |
| Specific | Kinesthetic | washout |
| effect | . . . | |
| weapons & | cold | melee weapons |
| combat | weapon | ranged weapons |
| | firearm | handguns |
| | | long gun |
| | | rifles & shotgun |
| | | machine guns |
| | electroshock | taser |
| | weapon | electric shock prods |
| | explosion | Mines |

Other strategies of pruning can be applied. One strategy can be based on the type of reference device used to design the haptic experience and thus, focusing only on the branch of this specific type of device. This pruning mechanism can be used to allocate more bits for deeper layer, or it can be used to delete extra bits from the representation. For example, an experience designed for smartphone could embed only the structure of the branch UX as shown in the following table.

| Layer 1 | Layer 2 | Layer 3 | | | | |
|---|---|---|---|---|---|---|
| UX | Button | click | double | | | |
| | | | click | | | |
| | Notification | Confirmation | Wrong | ring | message | . . . |

Back to FIG. 7, in a step S704, the decomposed semantic information is encoded. The decomposed semantic information may be encoded with a string of characters, e.g. in the interchange file 204, or may be encoded using a fixed or variable size binary representation. The binary representation of the decomposed semantic information may be inserted into the distribution stream 205. The encoding of semantic information associated with haptic effects does not replace encoding of keyframes. In an example, both keyframes and semantic information can be encoded to describe a haptic effect. The synthesizer may have to determine which information to use to do the rendering.

For the sake of simplicity, the representation of Table 2 is used in the following for the implementation details.

In a first example, the decomposed semantic information is encoded using a path allows to preserve the readability of the field as the JSON human readable format is intended to. This solution also facilitates the pruning strategy. The additional field is added at the effect level. The proposed change to the specification (ISO/IEC 23090-31: Haptics Coding, Committee Draft, section 6.2.8) is highlighted in bold below.

```
{
  “$schema”:“http://json-schema.org/draft-04/schema”,
  “title”:“MPEG_haptics_effect”,
  “type”:“object”,
  “properties”:{
    “id”:{
      “type”:“integer”,
      “description”:“Track Channel id”,
      “minimum”:0
    },
    “effect_type”:{
      “type”:“string”,
      “enum”:[
        “Basis”,
        “Composite”,
        “Reference”
      ],
      “description”:“Type of effect: basis, reference or composite”
    },
    “semantic”:{
      “type”:“string”,
      “description”:“Tag providing semantic information about the
effect. The Semantic information follows a hierarchical construct with
each layer of the semantic separated by a /”
    },
    “position”:{
      “type”:“integer”,
      “description”:“Temporal or spatial position of the effect”,
      “minimum”:0
    },
    “phase”:{
      “type”:“number”,
      “description”:“Phase of the effect”,
      “minimum”:0.0,
      “maximum”:6.28318
    },
    “keyframes”:{
      “type”:“array”,
      “description”:“List of keyframes”,
      “items”:{
        “type”:“object”,
        “$ref”:“MPEG_haptics.keyframes.schema.json”
      }
    },
    “base_signal”:{
      “type”:“string”,
      “enum”:[
        “Sine”,
        “Square”,
        “Triangle”,
        “SawToothUp”,
        “SawToothDown”
      ],
      “description”:“Type of the base signal”
    },
    “composition”:{
      “type”:“array”,
      “items”:{
        “effect”:{
          “type”:“object”,
          “$ref”:“MPEG_haptics.effect.schema.json”
        }
      }
    }
  },
  “required”:[
    “effect_type”,
    “position”,
    “phase”,
    “keyframes”
  ]
}
```

An example of an encoding of a decomposed semantic information is given below wherein the semantic information of the haptic effect “rain” is represented hierarchically as “Ambient/Water/Rain” according to the hierarchical structure of Table 2.

```
{
  “effect_type”:“Basis”,
  “position”:0,
  “phase”:0.0,
  “base_signal”:“Square”,
  “semantic”:“Ambient/Water/Rain”,
  “keyframes”:[
    {
      “relative_position”:0,
      “amplitude_modulation”:−0.003921568393707275,
      “frequency_modulation”:8
    },
    {
      “relative_position”:5,
      “amplitude_modulation”:1.0
    },
    {
      “relative_position”:30,
      “amplitude_modulation”:1.0
    },
    {
      “relative_position”:60,
      “amplitude_modulation”:−0.003921568393707275,
      “frequency_modulation”:8
    }
  ]
}
```

Below are other examples of encoding of decomposed semantic information for haptic effects “Click”, “Collision” and “Doors”.

The semantic information of the haptic effect “Click” is represented hierarchically as “UX/Button/Click” according to the hierarchical structure of Table 2.

```
{
  “effect_type”:“Basis”,
  “position”:0,
  “phase”:0.0,
  “base_signal”:“Square”,
  “semantic”:“UX/Button/Click”,
  “keyframes”:[
  ]
}
```

The semantic information of the haptic effect “Collision” is represented hierarchically as “Character Movements/Interaction/Collision” according to the hierarchical structure of Table 2.

```
{
  “effect_type”:“Basis”,
  “position”:0,
  “phase”:0.0,
  “base_signal”:“Square”,
  “semantic”:“Character Movements/Interaction/Collision”,
  “keyframes”:[
}
```

The semantic information of the haptic effect “Collision” is represented hierarchically as “Vehicles/Motorized/Doors” according to the hierarchical structure of Table 2.

```
{
  “effect_type”:“Basis”,
  “position”:0,
  “phase”:0.0,
  “base_signal”:“Square”,
  “semantic”:“Vehicles/Motorized/Doors”,
  “keyframes”:[
  ]
}
```

In a second example, the decomposed semantic information is encoded using a graph-like structure in the JSON human readable format. For each effect, the field semantic is represented with node.

The additional field is added at the effect level. The proposed change to the specification is illustrated in bold bellow.

```
{
  “$schema”:“http://json-schema.org/draft-04/schema”,
  “title”:“MPEG_haptics_effect”,
  “type”:“object”,
  “properties”:{
    “id”:{
      “type”:“integer”,
    “description”:“Track Channel id”,
      “minimum”:0
    },
    “effect_type”:{
      “type”:”string”,
      “enum”:[
        “Basis”,
        “Composite”.
        “Reference”
      ],
      “description”:“Type of effect: basis, reference or composite”
    },
    “semantic”:{
      “type”:“object”,
      “$ref”:“MPEG_{—}haptics.semanticTag.schema.json”,
      “description”:“Tag providing semantic information about the effect. The
Semantic information follows hierarchical construct with each layer of the semantic
defined by a number, a name and a potential child.”
    },
    “position”:{
      “type”:“integer”,
      “description”:“Temporal or spatial position of the effect”,
      “minimum”:0
    },
    “phase”:{
      “type”:“number”,
      “description”:“Phase of the effect”,
      “minimum”:0.0,
      “maximum”:6.28318
    },
    “keyframes”:{
      “type”:“array”,
      “description”:“List of keyframes”,
      “items”:{
        “type”:“object”,
        “$ref”:“MPEG_haptics.keyframes.schema.json”
      }
    },
    “base_signal”:{
      “type”:“string”,
      “enum”:[
        “Sine”,
        “Square”,
        “Triangle”,
        “SawToothUp”,
        “SawToothDown”
      ],
      “description”:“Type of the base signal”
    },
    “composition”:{
      “type”:“array”,
      “items”:{
        “effect”:{
          “type”:“object”,
          “$ref”:“MPEG_haptics.effect.schema.json”
        }
      }
    }
  },
  “required”:[
    “effect_type”,
    “position”,
    “phase”,
    “keyframes”
  ]
}
```

The following table details the JSON scheme of the proposed semanticTag object (it follows a graph-like structure).

```
{
  “$schema”:“http://json-schema.org/draft-04/schema”,
  “title”:“MPEG_{—}haptics_{—}semanticTag”,
  “type”:“object”,
  “properties”:{
    “layer”:{
      “type”:“integer”,
      “description”:“Track Channel id”,
      “minimum”:0
    },
    “name”:{
      “type”:“string”,
      “enum”:[
        “Basis”,
        “Composite”,
        “Reference”
      ],
      “description”:“Type of effect: basis, reference or composite”
    },
    “child”:{
      “type”:“object”,
      “$ref”:“MPEG_{—}haptics.effect.semanticTag.schema.json”
    },
  },
  “required”:[
    “layer”,
    “name”
  ]
}
```

Finally, the following table gives an example of encoding of a decomposed semantic information for the haptic effect “Rain”.

```
}
  “effect_type”:“Basis”,
  “position”:0,
  “phase”:0.0,
  “base_signal”:“Square”,
  “semantic”:{
    “layer”:1,
    “name”:“Ambient”,
    “child”:{
      “layer”:2,
      “name”:“Water”,
      “child”:{
        “layer”:3,
        “name”:“Rain”
      }
    }
  },
  “keyframes”:[
    {
      “relative_position”:0,
      “amplitude_modulation”:−0.003921568393707275,
      “frequency_modulation”:8
    },
    {
      “relative_position”:5,
      “amplitude_modulation”:1.0
    },
    {
      “relative_position”:30,
      “amplitude_modulation”:1.0
    },
    {
      “relative_position”:60,
      “amplitude_modulation”:−0.003921568393707275,
      “frequency_modulation”:8
    }
  ]
}
```

Below are other examples of encoding of decomposed semantic information for haptic effects “Click”, “Collision” and “Doors”.

The semantic information of the haptic effect “Click” is represented hierarchically as follows according to the hierarchical structure of Table 2.

```
{
  “effect_type”:“Basis”,
  “position”:0,
  “phase”:0.0,
  “base_signal”:“Square”,
  “semantic”:{
    “layer”:1,
    “name”:“UX”,
    “child”:{
      “layer”:2,
      “name”:“Button”,
      “child”:{
        “layer”:3,
        “name”:“Click”
    },
    “keyframes”:[
    ]
  }
}
```

The semantic information of the haptic effect “Collision” is represented hierarchically as follows according to the hierarchical structure of Table 2.

```
{
  “effect_type”:“Basis”,
  “position”:0,
  “phase”:0.0,
  “base_signal”:“Square”,
  “semantic”:{
    “layer”:1,
    “name”: “Movement”,
    “child”:{
      “layer”:2,
      “name”:“Interaction”,
      “child”:{
        “layer”:3,
        “name”:“Collision”
      }
    },
    “keyframes”:[
    ]
  }
}
```

The semantic information of the haptic effect “Doors” is represented hierarchically as follows according to the hierarchical structure of Table 2.

```
{
  “effect_type”:“Basis”,
  “position”:0,
  “phase”:0.0,
  “base_signal”:“Square”,
  “semantic”:{
    “layer”:1,
    “name”:“ Vehicles ”,
    “child”:{
      “layer”:2,
      “name”:“ Motorized ”,
      “child”:{
        “layer”:3,
        “name”:“Doors”
      }
    },
    “keyframes”:[
    ]
  }
}
```

In other examples disclosed below, each layer in the hierarchical structure is represented using a defined number of bits. The multi-layer hierarchical structure may be represented using a fixed size binary representation or using a varying size binary representation. For example, Table 8 shows an example of a fixed-size binary representation with an arbitrary number N of layers. The number of allocated bits for each layer also provides room for future additions of new effects without having to change the structure itself.

TABLE 8

| First layer | Second Layer | . . . | N^{th} layer |
|---|---|---|---|
| X₁ bits | X₂ bits | . . . | X_{N} bits |

The total structure may be represented using

$${\sum }_{i = 0}^{N} {X}_{i}$$

bits with a maximum of

$${2}^{{\sum }_{i = 0}^{N} {X}_{i}}$$

haptic effects represented using this configuration. The multi-layer hierarchical structure can be easily stored using a binary representation with a limited number of bits tackling the issue of bitrate induced when using string and allowing more flexibility than using a simple enumeration. The structure of FIG. 9 can thus be represented with 6 bits. The first layer could be represented using a minimum of 3 bits since 6 high-level concepts are identified. The second layer contains at most 2 elements for each primary concept which mean it could be represented on 1 bit. The same can be observed for the third and fourth layer so both can be represented using 1 bit as well. Table 9 shows a binary representation of the hierarchical structure of FIG. 9.

TABLE 9

| First layer | Second Layer | Third Layer | Fourth layer |
|---|---|---|---|
| 3 bits | 1 bit | 1 bit | 1 bits |

Table 10 is an example of binary representation on 3 bits of each concept depicted on FIG. 9. The same principles apply for the structure defined on Table 2.

TABLE 10

| Layer 1 | Binary representation of Layer 1 |
|---|---|
| UX | 000 |
| Environment | 001 |
| Videogame | 010 |
| Special effect | 011 |
| Music | 100 |
| Transportation | 101 |

Table 11 is an example of binary representation on 1 bit of each concept depicted on FIG. 9 in the case where the first layer concept is “environment”. The same principles apply for the other concepts of Layer 1.

TABLE 11

| | | Binary | | Binary |
|---|---|---|---|---|
| | | representation | | representation |
| Layer 1 | Layer 2 | of Layer 2 | Layer 3 | of Layer 3 |
| Environment | Water | 0 | Wave | 0 |
| | | | Rain | 1 |
| | Fire | 1 | Cracking wood | 0 |
| | | | Heat | 1 |

Therefore, the semantic information for the haptic effect “Heat” decomposed into “Environment/Fire/Heat” may be represented with the binary number 001 1 1 0. The first three bits “001” identify the concept “environment, the next bit “1” identifies “Fire”, the third bit “1” identifies “heat”. The last bit is set to “0” since no semantic information is specified at the fourth level. The decomposed semantic information may be added to the distribution stream 205 for example during the formatting step S220.

The structure of Table 2 can be represented with 8 bits as depicted on Table 12 below. Indeed, the first layer could be represented using a minimum of 3 bits since 8 high-level concepts are identified. The second layer contains at most 4 elements for each primary concept which mean it could be represented on 2 bits. The third layer contains at most 8 elements (in the case of Vehicle/motorized) which mean it could be represented on 3 bits.

TABLE 12

| | Layer 1 | Layer 2 | Layer 3 |
|---|---|---|---|
| Maximum number | 8 | 4 | 8 |
| elements | | | |
| Number of bits | 3 | 2 | 3 |

In one example, the number of bits used to represent the semantic of the effect can stay the same regardless of the profile or profile level used.

The semantic information for the haptic effect “Click” decomposed into “UX/Buttons/Click” may be represented with the binary number 000 00 000. Indeed “000” encodes the concept “UX”, “00” encodes “Buttons” and 000 encodes “Click”.

The semantic information for the haptic effect “Collision” may be encoded for example by the binary number 001 01 000. “001” encodes the concept “Character Movements”, i.e. the second concept in Table 2, “01” encodes “Interaction” and “000” encodes “collision”. “Jumping” would be encoded by 001 00 001.

Table 13 gives an example of a binary representation for the semantic information associated with “vehicles” concept. Binary representation is specified in parenthesis.

TABLE 13

| | | | | | mechanical | | | | |
|---|---|---|---|---|---|---|---|---|---|
| | | | | | part | | tires | air | vehicle |
| Vehicles | Motorized | Engine | Doors | Brake | moving | Drift | gripping | friction | bump |
| (110) | (00) | (000) | (001) | (010) | (011) | (100) | (101) | (110) | (111) |

| | | | |
|---|---|---|---|
| Unmotorized | road | Brake | Bump |
| (01) | friction | (001) | (010) |
| | (000) | | |

The semantic information for the haptic effect “Doors” may be encoded for example by the binary number 110 00 001. “110” encodes the concept “Vehicle”, “00” encodes motorized (first concept in the second layer), and “001” encodes “doors” (“second haptic effect in the third layer”). “Brake” would be encoded as 110 00 010.

Using such a fixed-size binary representation forces the hierarchical structure to be represented using the same number of bits. In this mode of representation, the total number of bits used for the structure is fixed but, for each layer, the number of bits can vary.

The fixed-size binary representation still allows to perform structure pruning with the advantage of allocating more bits for the remaining branches or for the different layers. This mode has the advantage of ensuring a stable bitrate for all binary encoded haptic experiences. The following Table 14 defines an example of a bitstream syntax that can be used for the binary representation of semantic information of a haptic effect. It uses an optional semantic flag “hasSemantic” and a syntax element “effectSemantic” that encodes the decomposed semantic information of an haptic effect. The example of Table 14 is based on the hierarchical structure proposed in Table 2. The syntax element “effectSemantic” is thus encoded on 8 bits: 3 bits for the first layer, 2 bits for the second layer and 3 bits for the third layer. The same syntax could be used for a different hierarchical structure, it would only require to adjust the number of allocated bits to match the structure. As an example, for the structure of FIG. 9 effectSemantic may be encoded on 6 bits instead of 8. A Boolean (semantic flag “hasSemantic”) is also encoded that indicates whether semantic information (a.k.a tag) is associated or not with the haptic effect.

TABLE 14

| | No. of | |
|---|---|---|
| Syntax | bits | Mnemonic |
| readEffect( ) { | | |
| id; | 16 | uimsbf |
| effectType; | 2 | uimsbf |
| effectPosition; | 25 | imsbf |
| hasSemantic | 1 | boolean |
| if(hasSemantic){ | | |
| effectSemantic | 8 | uimsbf |
| } | | |
| if (effectType == 0) { | | |
| readEffectBasis( ); | | |
| } | | |
| } | | |

In another example, a varying layer depth binary representation is used. The varying-size binary representation allows to shrink the hierarchical structure binary representation depending on the need. It requires either to know the number of bits used depending on the used pruning mechanism or to add a field to indicate the number of bits used.

The number of bits allocated to represent the structure may vary depending on the profile used and thus limiting the depth of the hierarchical structure encoded or restrain to some branches of the structures relevant for the haptic experience conveyed. Using varying layer depth binary representation has the advantage of providing flexibility and gain in bitrate for the binary encoded haptic experiences while conveying essential information.

The following Tables 15 and 16 define an example of a bitstream syntax that can be used for the varying layer depth binary representation of semantic information of a haptic effect. Here, before reading a semantic tag (a.k.a an element of the decomposed semantic information), the layer of the tag is encoded. Based on the associated structure (Table 2 in this example), the syntax indicates the number of bits to read in order to get the semantic tag. The layer 0 corresponds to no semantic information. With this solution, a semantic tag can be defined at any layer of the structure, it is not required to provide the information of the lower layers.

TABLE 15

| | No. of | |
|---|---|---|
| Syntax | bits | Mnemonic |
| readEffect( ) { | | |
| id; | 16 | uimsbf |
| effectType; | 2 | uimsbf |
| effectPosition; | 25 | Imsbf |
| readSemanticTag( ) | | |
| if (effectType == 0) { | | |
| readEffectBasis( ); | | |
| } | | |
| } | | |

TABLE 16

| | No. of | |
|---|---|---|
| Syntax | bits | Mnemonic |
| readSemanticTag( ) { | | |
| layer | 2 | uimsbf |
| if(layer==1){ | | |
| semanticLayer1 | 3 | uimsbf |
| }esleif(layer ==2){ | | |
| semanticLayer2 | 5 | |
| } esleif(layer ==3){ | | |
| semanticLayer2 | 8 | uimsbf |
| } | | |
| } | | |

The syntax element “layer” indicates the layer depth, i.e. the number of layer(s) to read, of the semantic information (a.k.a. tag). If 0, the effect does not contain any semantic information. The syntax element “semanticLayerN” indicates the semantic tag of the Nth layer from the semantic hierarchical structure.

For example, in the case where layer==2, five bits are encoded (respectively read on the decoder side), 3 for the first layer and 2 for the second layer.

The varying layer depth binary representation can be of use in the case where the mechanism of pruning is used, thus allowing to save bitrate. Given the representation for the simple parametric profile level 2 mentioned in Table 5, the binary representation uses 6 bits as mentioned in Table 17. This representation allows to save 2 bits for each effect in the haptic experience.

TABLE 17

| | Layer 1 | Layer 2 | Layer 3 |
|---|---|---|---|
| Maximum number | 4 | 2 | 5 |
| elements | | | |
| Number of bits | 2 | 1 | 3 |

The semantic information “UX” may be encoded with the binary number 01 00. “01” indicates a layer depth equal to 1 and the next two bits represent the tag UX.

The semantic information for the haptic effect “Click” may be encoded for example by the binary number 11 00 0 000. “11” indicates a layer depth equal to 3, therefore 6 bits are then encoded (respectively read), namely 2 bits for layer 1 (“00” thus indicates UX), 1 for layer 2 (“0” indicates “Button”) and 3 bits for layer 3 (“000” indicates “Click”).

The semantic information for the haptic effect “Collision” may be encoded for example by the binary number 11 01 1 000. “11” indicates a layer depth equal to 3, therefore 6 bits are then encoded (respectively read), namely 2 bits for layer 1 (“01” thus indicates “Character movements”), 1 for layer 2 (“1” indicates “Interaction”) and 3 bits for layer 3 (“000” indicates “Collision”).

For the representation of “Doors”, no semantic information exists in this pruned version of the representation. In that case, the haptic effect can only be defined using keyframes description.

In another example, a varying-size binary representation is used. In this example, a fully flexible hierarchical representation is defined. In this example, the number of bits used for a given layer is indicated in the binary stream. This allows to only use the minimum number of bits for a given layer and allows to eventually adapt to any hierarchical data structure. For instance, no matter the profile used, the decoder would be able to decode the data without prior knowledge on the profile, namely information would be needed to interpret the decoded data but not to decode the data as in the previous embodiment. In addition, if the standard were to update the proposed hierarchical semantic structure, the decoder would still be able to read the data.

In this example, the number of bits used for each node of the hierarchical structure may be different. The solution could also be used to store the first elements of a layer with fewer bits than the last elements. For instance, in Table 2, the semantic information (a.k.a tag) UX/Notification/Confirmation can be encoded using only one bit for the third layer while the “ring” or “message” tags would require 2 bits.

In this embodiment, as detailed in the following tables, for each haptic effect the layer depth, i.e. the number of layers to read, and the number of bits to read is indicated in the bitstream.

| | No. of | |
|---|---|---|
| Syntax | bits | Mnemonic |
| readEffect( ) { | | |
| id; | 16 | uimsbf |
| effectType; | 2 | uimsbf |
| effectPosition; | 25 | Imsbf |
| readSemanticTag( ) | | |
| if (effectType == 0) { | | |
| readEffectBasis( ); | | |
| } | | |
| } | | |

| | No. of | |
|---|---|---|
| Syntax | bits | Mnemonic |
| readSemanticTag( ) { | | |
| layer | 2 | uimsbf |
| if(layer>0){ | | |
| readSemanticLayer(layer) | | |
| } | | |
| } | | |

The syntax element “layer” indicates the layer depth of the semantic information. If 0, the effect does not contain any semantic information.

| | No. of | |
|---|---|---|
| Syntax | bits | Mnemonic |
| readSemanticLayer(layer) { | | |
| layerBitSize | 2 | uimsbf |
| semanticLayer | layerBitSize | uimsbf |
| if(layer>0){ | | |
| readSemanticLayer(layer-1) | | |
| } | | |
| } | | |

The syntax element “layerBitSize” indicates the number of bits used to store the semantic information of the layer

The syntax element “semanticLayer” indicates the semantic tag of the layer. It matches the information defined in the semantic hierarchical structure.

Similar to the previous embodiment, the solution also includes the information on the number of bits to read for each layer. Given the representation for the simple parametric profile level 2 mentioned in Table 5, here are some examples of semantic information/tags representation:

The semantic information “UX” may be encoded with the binary number 01 01 0.

| | |
|---|---|
| Layer depth | Layer 1 |

| 01 | 01 | 0 |
|---|---|---|
| 1 layer | 1 bit | first value: UX |

The semantic information “Click” may be encoded with the binary number 11 01 0 01 0 01 0

| Layer | | | | | | |
|---|---|---|---|---|---|---|
| depth | Layer 1 | | Layer 2 | | Layer 3 | |
| 11 | 01 | 0 | 01 | 0 | 01 | 0 |
| 3 layers | 1 bit | first value: | 1 bit | first value: | 1 bit | first value: |
| | | UX | | Button | | Click |

The semantic information “Touching” may be encoded with the binary number 11 01 1 01 1 10 10.

| Layer | | | | | | |
|---|---|---|---|---|---|---|
| depth | Layer 1 | | Layer 2 | | Layer 3 | |
| 11 | 01 | 1 | 01 | 1 | 10 | 10 |
| 3 layers | 1 bit | second value: | 1 bit | second value: | 2 | third value: |
| | | Movement | | Interaction | bits | Touching |

The semantic information “Touching” may be encoded with the binary number 11 10 11 01 0 011 1.

| Layer | | | | | | |
|---|---|---|---|---|---|---|
| depth | Layer 1 | | Layer 2 | | Layer 3 | |
| 11 | 10 | 11 | 01 | 0 | 01 | 1 |
| 3 layers | 2 | fourth value: | 1 bit | first value: cold | 1 bit | second value: |
| | bits | weapons & combat | | weapon | | hit |

FIG. 8 depicts a flowchart of a decoding method according to an example.

In a step S800, a stream (either a distribution stream 205 or an interchange file 204) is obtained that contains semantic information hierarchically encoded into layers by the method of FIG. 7. In a step S802, the semantic information (a.k.a. tag) is decoded. As an example, a sequence of bits 001 1 1 0 is decoded into the semantic information “Environment/Fire/Heat” in the case where the semantic information was encoded according to the example disclosed with respect to Tables 10 and 11.

In a variant a string of characters is obtained in the case where the semantic information is encoded in a human readable file with such a string of character.

In a step S804, this semantic information is used to render a haptic effect. The decoded semantic information may come in addition to the keyframe representation of an effect. Therefore, on a rendering side, the renderer may either use the semantic information or the keyframe information to render a haptic effect. Said otherwise, the synthesizer determines which information to use to do the rendering. In an example, the synthesizer may decide to use the decoded semantic information. This representation allows building standard libraries of haptic effects for each actuator facilitating the creation of content agnostic of the haptic devices that will render the experience. This representation also allows to signal special haptic effect that can be interpreted by the synthesizer depending on the type of haptic device used.

As an example, when decoding “Environment/Fire/Heat”, the synthesizer may access a standard library of haptic effects and render the haptic effect “Heat” from the library instead of rendering the haptic effect represented in the stream by the keyframe(s). Therefore, it ensures that the rendered effect is adapted to the capabilities of the rendering device.

Furthermore, the use of this type of hierarchical structure allows to easily perform data reduction by removing unnecessary data. This can be done by removing all the effects of a haptic signal that match a given semantic or on the contrary only keep effects associated with a specific semantic. This can typically be used to optimize the streaming of haptic data and only send the necessary information. This type of request can typically be done based on limitations of the accessible devices or simply based on the preferences of the user. For instance, if a complete haptic experience with numerous effects of different semantics is stored on a server, a client may request to only get the data associated with UX/notifications semantic information. The proposed solution allows to select the appropriate data by only selecting effects with a semantic tag UX/notification and then only stream the required information. This type of data filtering can be performed at different semantic levels. It can be used to select or remove data based on high level semantic information (first layer of the structure) or to select precisely the data with high definition semantic data (lower semantic layers).

Various numeric values are used in the present application. The specific values are for example purposes and the aspects described are not limited to these specific values.

In an embodiment, the encoding principle of the first or second method is applied to perform the encoding of an audio signal. Such audio signal may represent any type of audio communication such as a background soundtrack, a sound effect (e.g. explosion) or a voice communication between two users. The audio signal may be part of an immersive scene or can be independent from any immersive scene but using the same format as described in FIG. 5. In addition, an audio signal is sometimes used to render a haptic signal, after a low-pass filtering stage. This encoding technique may particularly be interesting for low frequencies such as an audio signal for a subwoofer. All the encoding principles are the same as described above in the context of low-level haptic signals but applied to a more general audio signal or a set of signals (for example: stereo, 5.1 multi-channel audio, etc.). Indeed, a low-level haptic signal is very similar to an audio signal and shares the same characteristics. Such embodiment could therefore be applied to any audio distribution system and the resulting encoded data could be stored on a removable media (for example: memory card, USB stick, hard disk drive, solid-state disk, optical media, etc.) or transmitted over a communication network.

When multiple frequency bands are encoded using keyframes, the principles described in the first or second embodiment are used for each of the frequency bands encoded using keyframes. Resulting residual signals may be encoded separately as different frequency bands or combined together in a single frequency band.

Although embodiments have been described mainly using a decomposition into two frequency bands, the principles of the first and second embodiment easily apply to an application where the decomposition uses more than two frequency bands.

A number of embodiments has been described above. Features of these embodiments can be provided alone or in any combination, across various claim categories and types.

In an example, a method is disclosed that comprises:
obtaining semantic information associated with at least one haptic effect;
decomposing said semantic information into different levels of semantic information based on (e.g., responsive to) a multi-layer hierarchical structure of semantic information; and encoding said decomposed semantic information.

In an example, encoding said decomposed semantic information comprises encoding the decomposed semantic information as a sequence of successive strings, said sequence comprising one string per level of semantic information.

In an example, encoding said decomposed semantic information comprises encoding the decomposed semantic information as a sequence of successive strings organized as a graph-like structure.

In an example, encoding said decomposed semantic information comprises encoding each level of semantic information using a fixed number of bits.

In an example, encoding said decomposed semantic information comprises encoding a first syntax element indicating a depth layer for the semantic information and further encoding a second syntax element representative of the decomposed semantic information on a number of bits which depends on said depth layer.

In an example, encoding said decomposed semantic information comprises encoding a first syntax element indicating a depth layer for the semantic information, for each layer, encoding a second syntax element indicating a number of bits used to encode the decomposed semantic information for the layer and encoding, on said indicated number of bits, a third syntax element representative of the decomposed semantic information for the layer.

In an example, the multi-layer hierarchical structure of semantic information depends on an encoding profile.

An apparatus comprising one or more processors and at least one memory coupled to the one or more processors is disclosed wherein the one or more processor is configured to: obtain semantic information associated with at least one haptic effect;
decompose said semantic information into different levels of semantic information based on (e.g., responsive to) a multi-layer hierarchical structure of semantic information; and
encode said decomposed semantic information.

A method for rendering a haptic effect is also disclosed that comprises:

obtaining a stream comprising semantic information hierarchically encoded into layers, said semantic information being associated with the haptic effect;
decoding said semantic information; and
rendering the haptic effect based on (e.g., responsive to) the decoded semantic information.

A rendering apparatus comprising one or more processors and at least one memory coupled to the one or more processors is disclosed wherein the one or more processor is configured to: obtain a stream comprising semantic information hierarchically encoded into layers, said semantic information being associated with a haptic effect;
decode said semantic information; and
render the haptic effect based on (e.g., responsive to) the decoded semantic information.

A computer readable storage medium having stored thereon instructions for implementing the any of the methods disclosed above is further disclosed.

Although embodiments are related to haptic effects, the person skilled in the art will appreciate that the same principles could apply to other effects such as the sensorial effects for example and thus would comprise smell, taste, temperature, emotions, intensity highlights, etc. Appropriate syntax would thus determine the appropriate parameters related to these effects. Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising:
obtaining a metadata file comprising semantic information associated with at least one haptic effect;
decomposing the semantic information into different levels of semantic information based on a multi-layer hierarchical structure of semantic information; and
encoding the decomposed semantic information into a data stream.

2. The method of claim 1, wherein encoding the decomposed semantic information into a data stream comprises encoding the decomposed semantic information as a sequence of successive strings, the sequence comprising one string per level of semantic information.

3. The method of claim 1, wherein encoding the decomposed semantic information into a data stream comprises encoding the decomposed semantic information as a sequence of successive strings organized as a graph-like structure.

4. The method of claim 1, wherein encoding the decomposed semantic information into a data stream comprises encoding each of the levels of semantic information using a fixed number of bits.

5. The method of claim 1, wherein encoding the decomposed semantic information into a data stream comprises encoding a first syntax element indicating a depth layer for the semantic information and further encoding a second syntax element representative of the decomposed semantic information on a number of bits which depends on the depth layer.

6. The method of claim 1, wherein encoding the decomposed semantic information into a data stream comprises encoding a first syntax element indicating a depth layer for the semantic information, for each layer, encoding a second syntax element indicating a number of bits used to encode the decomposed semantic information for the layer and encoding, on the indicated number of bits, a third syntax element representative of the decomposed semantic information for the layer.

7. (canceled)

8. An apparatus comprising one or more processors and at least one memory coupled to the one or more processors, the one or more processors being configured to perform:
obtaining a metadata file comprising semantic information associated with at least one haptic effect;
decomposing the semantic information into different levels of semantic information based on a multi-layer hierarchical structure of semantic information; and
encoding the decomposed semantic information into a data stream.

9-12. (canceled)

13. The apparatus of claim 8, wherein encoding the decomposed semantic information into a data stream comprises encoding the decomposed semantic information as a sequence of successive strings, the sequence comprising one string per level of semantic information.

14. The apparatus of claim 8, wherein encoding the decomposed semantic information into a data stream comprises encoding the decomposed semantic information as a sequence of successive strings organized as a graph-like structure.

15. The apparatus of claim 8, wherein encoding the decomposed semantic information into a data stream comprises encoding each of the levels of semantic information using a fixed number of bits.

16. The apparatus of claim 8, wherein encoding the decomposed semantic information into a data stream comprises encoding a first syntax element indicating a depth layer for the semantic information and further encoding a second syntax element representative of the decomposed semantic information on a number of bits which depends on the depth layer.

17. The apparatus of claim 8, wherein encoding the decomposed semantic information into a data stream comprises encoding a first syntax element indicating a depth layer for the semantic information, for each layer, encoding a second syntax element indicating a number of bits used to encode the decomposed semantic information for the layer and encoding, on the indicated number of bits, a third syntax element representative of the decomposed semantic information for the layer.

18. A method for rendering a haptic effect comprising:
obtaining a data stream comprising semantic information hierarchically encoded into layers, the semantic information being associated with the haptic effect;
decoding the semantic information; and
rendering the haptic effect based on the decoded semantic information.

19. The method of claim 18, wherein decoding the semantic information comprises decoding the semantic information as a sequence of successive strings, the sequence comprising one string per level of semantic information.

20. The method of claim 18, wherein decoding the semantic information comprises decoding the semantic information as a sequence of successive strings organized as a graph-like structure.

21. The method of claim 18, wherein decoding the semantic information comprises decoding each of the levels of semantic information using a fixed number of bits.

22. The method of claim 18, wherein decoding the semantic information comprises decoding a first syntax element indicating a depth layer for the semantic information and further decoding a second syntax element representative of the semantic information on a number of bits which depends on the depth layer.

23. The method of claim 18, wherein decoding the semantic information comprises decoding a first syntax element indicating a depth layer for the semantic information, for each layer, decoding a second syntax element indicating a number of bits used to encode the semantic information for the layer and decoding, on the indicated number of bits, a third syntax element representative of the semantic information for the layer.

24. A rendering apparatus comprising one or more processors and at least one memory coupled to the one or more processors, the one or more processors being configured to perform:
obtaining a data stream comprising semantic information hierarchically encoded into layers, the semantic information being associated with a haptic effect;
decoding the semantic information; and
rendering the haptic effect based on the decoded semantic information.

25. The rendering apparatus of claim 24, wherein decoding the semantic information comprises decoding the semantic information as a sequence of successive strings, the sequence comprising one string per level of semantic information.

26. The rendering apparatus of claim 24, wherein decoding the semantic information comprises decoding the semantic information as a sequence of successive strings organized as a graph-like structure.

27. The rendering apparatus of claim 24, wherein decoding the semantic information comprises decoding each of the levels of semantic information using a fixed number of bits.

28. The rendering apparatus of claim 24, wherein decoding the semantic information comprises decoding a first syntax element indicating a depth layer for the semantic information and further decoding a second syntax element representative of the semantic information on a number of bits which depends on the depth layer.

29. The rendering apparatus of claim 24, wherein decoding the semantic information comprises decoding a first syntax element indicating a depth layer for the semantic information, for each layer, decoding a second syntax element indicating a number of bits used to encode the semantic information for the layer and decoding, on the indicated number of bits, a third syntax element representative of the semantic information for the layer.
